(19) United States
(12) Patent Application Publication
(10) Pub. No.: US 2023/0221923 A1
(43) Pub. Date: Jul. 13, 2023

(54) Method and Device for Processing Sensor Data

(71) Applicant: Robert Bosch GmbH, Stuttgart (DE)

(72) Inventors: Peter Schneider, Holzgerlingen (DE); Andreas Heyl, Weil Der Stadt (DE)

(21) Appl. No.: 18/000,324

(22) PCT Filed: Jun. 7, 2021
(86) PCT No.: PCT/EP21/65142

§ 371 Date: Nov. 30, 2022

(30) Foreign Application Priority Data
Jun. 5, 2020 (DE) 10 2020 207 091.1

(51) Int. Cl. G06F 7/14; G06F 16/907

(52) U.S. Cl. CPC G06F 7/14; G06F 16/907

(57) ABSTRACT

A method for processing sensor data includes assessing the sensor data of a sensor using metadata of the sensor as well as sensor data of at least one additional sensor using the metadata of the additional sensor, in order to receive assessed sensor data of the sensors. The method further includes merging the assessed sensor data in order to receive merged sensor data.

### FIELD OF THE INVENTION

The invention relates to a method for processing sensor data and to a corresponding device.

### PRIOR ART

A sensor can detect objects within a detection range of the sensor. The sensor can detect the objects more or less effectively depending on where the objects are arranged in the detection range. If the sensor detects an object at a location at which a detection performance of the sensor is poor, the object may be imaged in sensor data of the sensor with a detection error.

### DISCLOSURE OF THE INVENTION

Against this background, the approach presented here provides a method for processing sensor data, a corresponding device, and lastly a corresponding computer program product and a machine-readable storage medium according to the independent claims. Advantageous developments and improvements of the approach presented here emerge from the description and are described in the dependent claims.

### Advantages of the Invention

Embodiments of the present invention may advantageously allow sensor data of a known sensor to be assessed or weighted while taking into account known properties of the sensor. As a result, detection errors or errors in the imaging of the detected objects in the sensor data can be taken into account when processing the sensor data further. For example, a detection uncertainty can be assigned to the detected objects.

A method for processing sensor data is presented, the sensor data of a sensor being assessed using metadata of the sensor and additional sensor data of at least one additional sensor being assessed using metadata of the additional sensor, in order to receive assessed sensor data of the sensors, the assessed sensor data being merged in order to receive merged sensor data. Preferably, the metadata describe detection uncertainties of the sensors and/or pre-existing integrities of the sensor data per measurement function of the sensors.

Ideas for embodiments of the present invention may be considered, inter alia, as being based on the concepts and findings described below.

A sensor may be an active sensor or a passive sensor. The sensor can detect objects within a detection range and image them in sensor data. Metadata of the sensor may be information about the sensor, describing, for example, a design-related imaging performance of the sensor. The metadata may also describe limitations of a detection performance of the sensor due to an installation position of the sensor. For example, a first portion of the detection range may be associated with greater uncertainty in the detection than a second portion of the detection range. If the sensor data displays an object in the first portion, the object can be assigned a greater detection uncertainty than if said object were displayed in the second portion. The object in the first portion may be assigned a greater integrity than the object in the second portion.

When merging or combining sensor data, information can be read out from data fields of the individual sensor data, and the information from said data fields of the different sensor data can be stored in a single data field of the merged sensor data. Preferably, sensor data with a lower detection uncertainty can be taken into account in the merging. In the simplest case, the information with the lowest detection uncertainty can be stored in the data field and the information with a greater detection uncertainty can be rejected. The merging may also be performed using a merging algorithm. In this case, the detection uncertainty can be used to weight the information.

In particular, embodiments of the method presented herein may be used, during operation of motor vehicles, to detect objects removed as a result of a data merging and to control the vehicle, or assist with the control of the vehicle, on the basis of that information. For example, the information obtained from the merged sensor data may be supplied to an assistance system in which the information is then used, for example, to influence the driving behavior of the vehicle by means of control components of the vehicle. In this case, the sensor data may be received by a sensor arrangement that comprises, for example, sensors of the vehicle. Information obtained from the merged sensor data in accordance with the proposed method may be used for controlling components in the vehicle and may ultimately assist with the control of the vehicle according to the situation.

The merged sensor data may be used, for example, for trajectory planning and/or behavior planning for a vehicle. For this purpose, objects detected by at least one of the sensors and represented in the merged sensor data can be detected. The detected objects can be classified. The trajectory planning can take account of objects classified as obstacles, and the trajectory for the vehicle may be planned around the obstacles. Using control signals, the vehicle may be steered along the planned trajectory without touching the obstacles.

The metadata of the sensor may be read out from a memory of the sensor. The metadata may be stored in the memory during production of the sensor, for example. Likewise, the metadata may be stored in the memory during installation of the sensor. Alternatively, parts of the metadata may be stored in the memory during production while other parts may not be stored until installation. The metadata may be generated on the basis of reference measurements of the sensor and stored in the memory.

The metadata of the sensor may be stored in a memory of a data processing apparatus and read out of the memory. A data processing apparatus may be part of a sensor system. The sensor may likewise be part of the sensor system. The metadata may be saved in the memory of the data processing apparatus during assembly of the sensor system. The data processing apparatus may read out the metadata from a memory of the sensor during assembly of the sensor system.

The metadata may be input via a standardized metadata interface. A metadata interface may define data fields in which the information can be stored or transmitted. The data fields may be occupied or remain free. Metadata can thus be read out from different sensors using the same metadata interface. Remote sensors may also be integrated into a sensor system using a standardized metadata interface. In this case, the sensors may be part of a surrounding infrastructure, for example.

The metadata may map static properties of the sensor. Static capabilities may, for example, be capabilities and/or insufficiencies of the sensor. Static properties may be a distortion caused by a lens of the sensor, for example. The distortion may be stronger or weaker over different regions of the detection range. For example, edge regions of the detection range may be more distorted than central regions of the detection range. The static properties may also relate to a sensitivity of a sensor element of the sensor. The sensor element may have different sensitivities to different wavelengths, for example.

The metadata may also map variable properties of the sensor. At least one parameter currently influencing the sensor may be detected. The metadata may be parametrized using the at least one parameter. Variable properties may have different effects in different situations. For example, a radar sensor in a tunnel may detect ghost echoes in the region of the walls of the tunnel. The tendency of the radar sensor to detect ghost echoes may be stored in the metadata. If the tunnel is detected by the sensor or by another sensor, a “tunnel” parameter can be set and the ghost echoes can be ignored.

At least one current environmental condition at the sensor and/or within the detection range of the sensor may be captured as a parameter. Environmental conditions may significantly influence the perception performance of the sensor. For example, a sensor range may be significantly lower in fog than on a clear day. Likewise, a resolution of the sensor may be significantly lower when it is raining than when it is dry. An imaging performance of a camera may be lower in the dark than in light conditions.

The sensor data may be coordinate-based. The sensor-data information assigned to a coordinate of the sensor data may be assigned an item of metainformation stored in the metadata in relation to the coordinate, in order to assess the information. The detection range of the sensor may be divided into regions. Each region can be characterized by its coordinates. The coordinates may be two-dimensional or three-dimensional. Metadata can be assigned to each of the regions. The sensor data can be supplied in a coordinate-based manner. If a coordinate of an item of sensor-data information lies within the coordinates of a region, then the metadata of the relevant region can be applied to the information.

This method can be implemented, for example, in software or hardware or in a mixed form of software and hardware, for example in a control means.

The approach presented here further provides for a device which is configured to carry out, actuate or implement in corresponding apparatuses the steps of a variant of the method presented here.

The device may be an electrical instrument having at least one computing unit for processing signals or data, at least one memory unit for storing signals or data, and at least one interface and/or one communication interface for inputting or outputting data embedded in a communication protocol. The computing unit can, for example, be a signal processor, a so-called system ASIC, or a microcontroller for processing sensor signals and outputting data signals on the basis of the sensor signals. The memory unit can, for example, be a flash memory, an EPROM, or a magnetic memory unit. The interface can be designed as a sensor interface for reading the sensor signals from a sensor and/or as an actuator interface for outputting the data signals and/or control signals to an actuator. The communication interface can be designed to read or output the data in a wireless and/or wired manner. The interfaces may also be software modules that are present, for example, on a microcontroller in addition to other software modules.

A computer program product or a computer program with program code that can be stored on a machine-readable carrier or storage medium, such as a semiconductor memory, a hard disk memory, or an optical memory, and that is used for carrying out, implementing, and/or actuating the steps of the method according to one of the embodiments described above is advantageous as well, in particular when the program product or program is executed on a computer or an apparatus.

It is pointed out that some of the possible features and advantages of the invention are described herein with reference to different embodiments. A person skilled in the art recognizes that the features of the control means and of the method can be suitably combined, adapted, or replaced in order to arrive at further embodiments of the invention.

### BRIEF DESCRIPTION OF THE DRAWINGS

Embodiments of the invention are described below with reference to the accompanying drawings, and neither the drawings nor the description should be construed as limiting the invention.

FIG. 1 is an illustration of an information system comprising a device according to an exemplary embodiment; and

FIG. 2 is an illustration of metadata according to an exemplary embodiment.

The figures are merely schematic and not true to scale. In the figures, identical reference signs refer to identical or identically acting features.

### EMBODIMENTS OF THE INVENTION

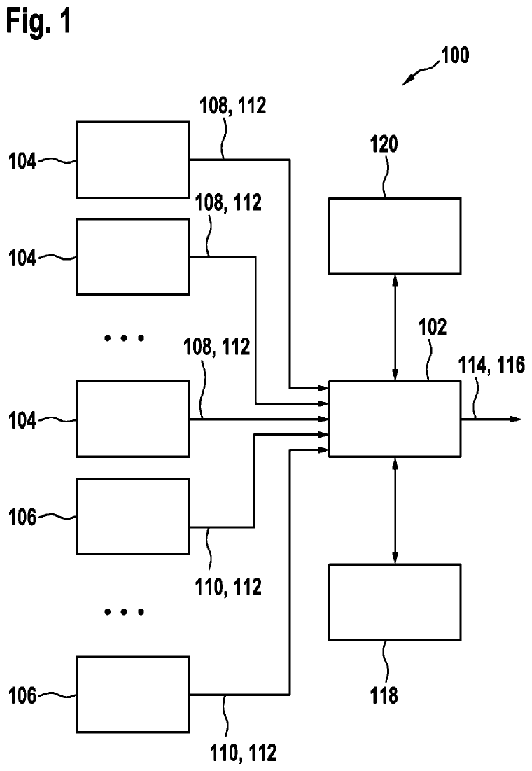

FIG. 1 is an illustration of an information system 100 comprising a device 102 according to an exemplary embodiment. The information system 100 is, for example, a sensor system of a vehicle. The information system 100 has a plurality of sensors 104 and a plurality of data sources 106. In this case, the information system comprises 1 to n sensors 104 and 1 to m data sources 106. Sensor data 108 of the sensors 104 and data 110 of the data sources are input by the device 102. In addition, metadata 112 of the sensors 104 are input by the device 102. In the process, metadata 112 of the data sources 106 may also be input. In the process, metadata 112 may also not be input for each sensor 104. For this reason, no metadata 112 may be present for some of the sensors 104. At least the sensor data 108 are assessed in the device 102 using the metadata 112 in order to receive assessed sensor data 114. During assessment, quality assessments are added to descriptions of objects imaged in the sensor data 108.

In one exemplary embodiment, the assessed sensor data 114 are combined or merged in order to receive merged sensor data 116. In this case, a description of an object imaged in more than the assessed sensor data 114 of one of the sensors 104 is supplemented by descriptions from the assessed sensor data 114 of at least one other of the sensors 104. During the combining to form the merged sensor data 116, the descriptions having the higher quality assessments are given greater weighting than the descriptions having the lower quality assessments.

In one exemplary embodiment, the sensor data 108 of a sensor are assessed in a location-dependent manner. In this case, coordinates 118 of an object imaged in the sensor data 108 are determined and assessed using metadata 112 assigned to the coordinates 118. For this reason, objects recognized at different coordinates 118 may also be assessed using different metadata 112.

In one exemplary embodiment, the metadata 112 are parametrized before the sensor data 108 are assessed. To parametrize the metadata 112 of a sensor 104, at least one parameter 120 influencing the sensor 104 is determined. The parameter 120 may, for example, map environmental conditions at the sensor 104.

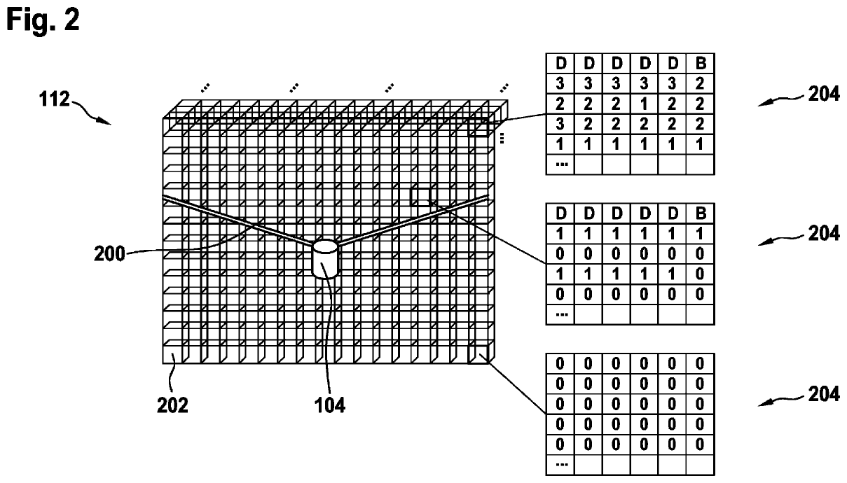

FIG. 2 is an illustration of metadata 112 of a sensor 104. The metadata 112 may be used for processing sensor data according to the approach presented here. The metadata 112 describe a detection quality of the sensor 104 over a detection range 200 of the sensor. The detection range 200 here is thus described three-dimensionally, i.e. spatially. Alternatively, the detection range may also be described two-dimensionally, i.e. in a planar manner.

The detection range 200 is divided into small portions 202. In this case, the portions 202 are cubic and substantially all of the same size. For each portion 202, metainformation 204 is stored in the metadata. The metadata 204 describe a detection quality of the sensor 104 for that portion 202.

In one exemplary embodiment, the metainformation 204 can be parametrized. In this case, the metainformation 204 is dependent on at least one current condition at the sensor and/or in the detection range 200.

In other words, what is presented is a safety interface for flexibly and dynamically using sensors in a safe sensor merging for automated driving.

The integrity class of a sensor (for example ASIL, SIL, PL) relates to specific functions of the sensor, not to the sensor as a component. This may lead to misunderstandings, such as an erroneous adaptation of the requirements.

ISO/PAS 21448 (SOTIF) points out that integrity alone is not decisive for whether sensor signals are usable in safety-related functions. Rather, the performance or insufficiencies of the sensor (based on individual measurement functions) may be taken into account in the safety concept or in the signal merging. Critical errors may, for example, be incorrect measurements, false positives (FP) or false negatives (FN).

In the approach presented here, a sensor supplies information about its capabilities, its safety integrity for specific functions (ISO 26262, IEC 61508, ISO 13849, IEC 62061, ISO 25119, etc.) and its insufficiencies (SOTIF, ISO/PAS 21448) via a standardized interface. This information can be referred to as metadata or “safety metadata.”

The capabilities and insufficiencies can be described on the basis of a geometric grid (e.g. a 3D cube grid) around the sensor; for this grid, quality classes per measurement function (color, object position, speed, etc.) can be defined depending on further parameters (e.g. environmental conditions, sensor state).

By means of the approach presented here, sensors can be combined more easily to form a sensor set that demonstrably achieves a required safety integrity and sufficient safety for the functionality (SOTIF, ISO/PAS 21448).

Sensors (or data sources) equipped with this standard interface can thus also be integrated into an existing sensor set on an ad hoc basis. For example, sensors in the road infrastructure (traffic control systems, systems of a mobility data marketplace) can be (temporarily) integrated into the merging (sensor/information) of a passing automated vehicle. In a similar scenario, sensors installed on construction sites can be integrated into the perception/merging of a construction site vehicle.

An integrity (QM-ASIL D, SIL 1-4, PLa-PLe) and a quality class (e.g. 1-4) can be stored as safety information of the interface (“safety metadata”) for all measurements, per measurement attribute (color, position, dynamics) and/or per grid element.

ODD-specific factors may be taken into account as influencing factors, for example internal and/or external use (protected or unprotected); stationary operation and/or mobile operation; temperature and humidity; precipitation (rain, hail or snow) and wind; pressure (of ambient air, water, etc.); solar irradiation and heat radiation; condensation and icing; fog, dust, sand and salt mist; vibrations and shaking; fauna and flora (e.g. mold formation); chemical influences; electrical and electromagnetic influences; mechanical loads; sound.

A current sensor state may also be taken into account as an influencing factor. In this respect, internal errors, heating and/or occlusion may be taken into account.

Known points of interest (POI), in the form of a GPS position with a direction, at which deterioration in the sensor performance or an increase in sensor errors caused by external effects has been detected during validation (“triggering events” as per ISO/PAS 21448) may also be taken into account as influencing factors.

The interface may be designed, for example, as a multi-dimensional characteristic matrix, a safety contract, as Conditional Safety Certificates (ConSerts) or as Conditional Dependability Certificates (DDI).

As in FIG. 2, the characteristic matrix may have 3D cubes as a grid geometry, for example. The cubes can be arranged, for example, in accordance with a grid used in the merging. An occupancy grid map may measure 10×10×10 cm, for example. The characteristic matrix may also have concentric circles as a grid geometry; these can be arranged equidistantly or at increasing distances from one another. The grid geometry may also be a mixed form of the two options. For each 3D grid element, the capabilities of the sensor are specified in a matrix together with safety attributes (integrity, conditional insufficiencies).

By means of the approach presented here, any sensors or information sources that are intended to be integrated into an existing sensor set of a system can be used (e.g. retrofitting, also “off-the-shelf” sensors). Sensors of other vehicles located in the vicinity can be used together with additional information about a (global) position and an orientation for transforming the 3D grid into the coordinates of the ego-vehicle. Sensors in the infrastructure, in traffic control systems or in systems installed in the context of a mobility data marketplace by third parties at the road edge, on buildings, etc. (smart cities), can also be used.

To supply the information, an intelligent sensor can itself determine the current capabilities and insufficiencies (possibly also the safety integrities, depending on transient errors) (preprocessing) and output them at the interface. Alternatively or additionally, the sensor can in advance supply specific validated and calibrated information as a characteristic matrix of an “expert system” in the above-described standardized format, so that the subsequent modules can evaluate this information according to their requirements.

From the data, the merging generates measures for the integrity and reliability or insufficiency (SOTIF) of specific information (“safety metadata”); these are taken into account in the later behavior and trajectory planning for the vehicle and may lead to limitations in behavior (slower driving, prohibition of specific maneuvers), for example if the information has low integrity or low reliability.

Sensors and further data sources deliver their data, including the information about the quality of the data, depending on conditions (e.g. environmental conditions, position). Use is made of these data in the merging to optimize the performance and integrity thereof. The merging result is forwarded to the subsequent modules together with an aggregated assessment of quality with regard to safety (integrity, reliability, confidence).

The data can, for example, also be centrally collected and supplied via an expert system on board the vehicle.

Finally, it should be pointed out that terms like “having,” “comprising,” etc. do not exclude other elements or steps and terms like “a” or “an” do not exclude a plurality. Reference signs in the claims are not to be considered as limiting.

1. A method for processing sensor data, comprising:
assessing sensor data of a sensor using metadata of the sensor;
assessing sensor data of at least one additional sensor using metadata of the additional sensor;
receiving the assessed sensor data of the sensor and the at least one additional sensor;
merging the assessed sensor data; and
receiving the merged sensor data.

2. The method according to claim 1, wherein the metadata of the sensor are read out from a memory of the sensor.

3. The method according to claim 1, wherein the metadata of the sensor are stored in a memory of a data processing apparatus and read out from the memory.

4. The method according to claim 1, further comprising:
inputting the metadata via a metadata interface.

5. The method according to claim 1, wherein the metadata map static properties of the sensor.

6. The method according to claim 1, wherein:
the metadata map variable properties of the sensor, and
at least one parameter currently influencing the sensor is detected and the metadata are parametrized using the at least one parameter.

7. The method according to claim 6, further comprising:
detecting at least one current environmental condition at the sensor and/or within a detection range of the sensor as the at least one parameter.

8. The method according to claim 1, wherein:
the sensor data are coordinate-based, and
an item of information assigned to a coordinate of the sensor data is assigned an item of metainformation stored in the metadata in relation to the coordinate, in order to assess the item of information.

9. A device configured to carry out, implement, and/or actuate in corresponding apparatuses the method according to claim 1.

10. The method according to claim 1, wherein a computer program product is configured to instruct a processor, when the computer program product is executed, to carry out, implement, and/or actuate the method.

11. A non-transitory machine-readable storage medium on which the computer program product according to claim 10 is stored.
